(19) United States
(12) Patent Application Publication
(10) Pub. No.: US 2025/0088060 A1
(43) Pub. Date: Mar. 13, 2025

(54) ELECTRIC MOTOR ASSEMBLY HAVING A TRAY

(71) Applicant: Schaeffler Technologies AG & Co. KG, Herzogenaurach (DE)

(72) Inventor: Vishal Jadhav, Kent, OH (US)

(73) Assignee: Schaeffler Technologies AG & Co. KG, Herzogenaurach (DE)

(21) Appl. No.: 18/654,244

(22) Filed: May 3, 2024

Related U.S. Application Data
(60) Provisional application No. 63/537,939, filed on Sep. 12, 2023.

(51) Int. Cl. H02K 3/50

(52) U.S. Cl. CPC H02K 3/50; H02K 2203/09

(57) ABSTRACT

An electric motor assembly includes a rotor and a stator that is disposed radially outboard of the rotor. The stator includes a stator core and a plurality of windings. The stator core extends axially in a first direction from a first axial end to a second axial end opposite the first axial end. The plurality of windings extend along the stator core. Each of the plurality of windings respectively includes a terminal end that is positioned axially beyond the second axial end of the stator core in the first axial direction. At least one of the plurality of windings is fixed to a busbar proximate to the terminal end of the at least one winding. A tray is coupled to and supports the busbar. The tray defines at least one receiver through which the at least one winding extends.

### CROSS-REFERENCE TO RELATED APPLICATION

This application claims the benefit of priority under 35 U.S.C. § 119 of U.S. Provisional Application No. 63/537,939, filed on Sep. 12, 2023, the entire contents of which are incorporated herein by reference.

### FIELD OF THE DISCLOSURE

The present disclosure generally relates to an electric motor assembly. More specifically, the present disclosure relates to an electric motor assembly that includes a tray for supporting a busbar and a plurality of apertures for receiving a corresponding plurality of windings therethrough.

### BACKGROUND OF THE DISCLOSURE

Electric motors often include windings that are fixed to busbars. During operation of these electric motors, forces may be applied to the windings that cause stress at the connection points between the windings and the busbar.

### SUMMARY OF THE DISCLOSURE

According to a first aspect of the present disclosure, an electric motor assembly includes a rotor and a stator that is disposed radially outboard of the rotor. The stator includes a stator core and a plurality of windings. The stator core extends axially in a first direction from a first axial end to a second axial end opposite the first axial end. The plurality of windings extend along the stator core. Each of the plurality of windings respectively includes a terminal end that is positioned axially beyond the second axial end of the stator core in the first axial direction. At least one of the plurality of windings is fixed to a busbar proximate to the terminal end of the at least one winding. A tray is coupled to and supports the busbar. The tray defines at least one receiver through which the at least one winding extends.

Embodiments of the first aspect of the disclosure can include any one or a combination of the following features:
the at least one receiver is positioned axially between the busbar and the stator core;
the at least one receiver extends from a first opening to a second opening that is axially offset from the first opening, and the portion of the tray that defines the at least one receiver tapers inward as the portion extends axially in the first axial direction, such that the first opening is larger than the second opening;
the tray is configured to maintain contact with the at least one winding at the second opening of the at least one receiver;
the at least one receiver comprises at least one aperture;
the at least one winding that extends through the at least one receiver defined by the tray is fixed to at least one of a radially-outboard-facing surface of the busbar and a radially-inboard-facing surface of the busbar;
the at least one winding that extends through the at least one receiver defined by the tray is fixed to the radially-outboard-facing surface of the busbar;
the at least one winding that extends through the at least one receiver defined by the tray is fixed to the radially-inboard-facing surface of the busbar;
the at least one receiver comprises at least one inner receiver defined by the tray, and at least one outer receiver that is defined by the tray and positioned radially outboard of the at least one inner receiver;
the at least one winding comprises at least one inner winding that extends through the at least one inner receiver defined by the tray and that is fixed to the radially-inboard-facing surface of the busbar, and at least one outer winding that extends through the at least one outer receiver defined by the tray and that is fixed to the radially-outboard-facing surface of the busbar;
the at least one inner receiver includes a plurality of inner receivers, the at least one outer receiver includes a plurality of outer receivers, the at least one inner winding includes a plurality of inner windings that respectively extend through the corresponding plurality of inner receivers, and the at least one outer winding includes a plurality of outer windings that respectively extend through the corresponding plurality of outer receivers;
the tray comprises a body that supports the busbar, an inner guide member that extends radially inboard from the body and defines the plurality of inner receivers, and an outer guide member that extends radially outboard from the body and defines the plurality of outer receivers;
a radially-inboard-most portion of the inner guide member at a given circumferential position occupied by the inner guide member is the radially-inboard-most portion of the tray at the given circumferential position occupied by the inner guide member; and
a radially-outboard-most portion of the outer guide member at a given circumferential position occupied by the outer guide member is the radially-outboard-most portion of the tray at the given circumferential position occupied by the outer guide member.

According to a second aspect of the present disclosure, a tray for an electric motor assembly includes a support structure configured to support at least one busbar of the electric motor assembly and defining a plurality of apertures configured to receive a corresponding plurality of windings therethrough that are configured to be fixed to the at least one busbar.

Embodiments of the second aspect of the disclosure can include any one or a combination of the following features:
at least one the plurality of apertures extends from a first opening to a second opening, and wherein the first opening is larger than the second opening;
the plurality of apertures includes a plurality of inner apertures and a plurality of outer apertures positioned radially outboard of the plurality of inner apertures, and wherein the support structure comprises a body that is configured to support the at least one busbar, an inner guide member that extends radially inboard from the body and defines the plurality of inner apertures, and an outer guide member that extends radially outboard from the body and defines the plurality of outer apertures;
a radially-inboard-most portion of the inner guide member at a given circumferential position occupied by the inner guide member is the radially-inboard-most portion of the tray at the given circumferential position occupied by the inner guide member; and
a radially-outboard-most portion of the outer guide member at a given circumferential position occupied by the outer guide member is the radially-outboard-most portion of the tray at the given circumferential position occupied by the outer guide member.

According to a third aspect of the present disclosure, an electric motor assembly includes a stator including a stator core and a plurality of windings that extend along the stator core, a busbar to which the plurality of windings are fixed, and a tray coupled to and supporting the busbar and defining a plurality of apertures through which the plurality of windings respectively extend.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a cross-sectional view of an electric drive unit that includes an electric motor assembly that has a stator and a rotor;

FIG. 2 is a perspective view of a portion of an electric motor assembly, illustrating a stator that includes a stator core and a plurality of windings, a plurality of busbars to which the plurality of windings are fixed, and a tray that supports the plurality of busbars and defines a plurality of apertures through which the plurality of windings extend, according to one embodiment;

FIG. 3 is an enlarged view of an area of the electric motor assembly of FIG. 2, according to one embodiment;

FIG. 4 is a side elevational view of a portion of the electric motor assembly, illustrating a busbar and a plurality of windings fixed to radially-inboard-facing and radially-outboard-facing surfaces of the busbar, according to one embodiment;

FIG. 5 is a perspective view of a portion of an electric motor assembly, illustrating a plurality of busbars and a plurality of windings fixed to the busbars, according to one embodiment;

FIG. 6 is a perspective view of a tray of the electric motor assembly, according to one embodiment;

FIG. 7 is a side elevational view of the tray of the electric motor assembly, according to one embodiment; and

FIG. 8 is a cross-sectional view of a portion of the tray of FIG. 6 taken at line VIII-VIII, illustrating a receiver defined by the tray that includes a first opening that is larger than a second opening.

The components in the figures are not necessarily to scale, emphasis instead being placed upon illustrating the principles described herein.

### DETAILED DESCRIPTION

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the term “axial” and derivatives thereof, such as “axially,” shall be understood to refer to a direction along the axis of a shaft configured to rotate in operation of the apparatus described herein. Further, the term “radial” and derivatives thereof, such as “radially,” shall be understood in relation to the axis of the aforementioned shaft. For example, “radially outboard” refers to further away from the axis, while “radially inboard” refers to nearer to the axis. The term “circumferential” and derivatives thereof, such as “circumferentially,” shall be understood in relation to the axis of the aforementioned shaft.

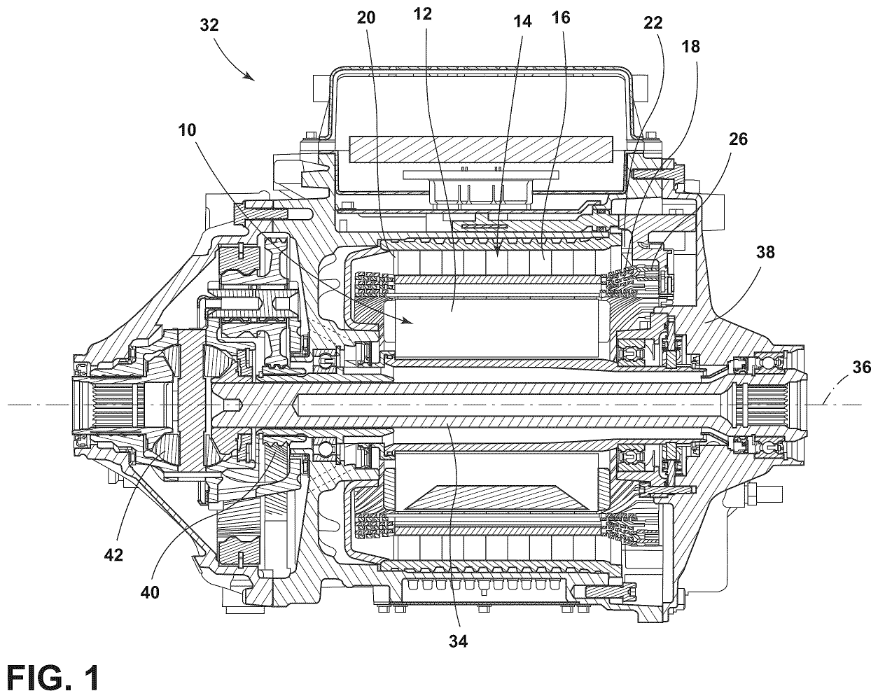

Referring now to FIGS. 1-8, an electric motor assembly 10 includes a rotor 12 and a stator 14 that is disposed radially outboard of the rotor 12. The stator 14 includes a stator core 16 and a plurality of windings 18. The stator core 16 extends axially in a first direction from a first axial end 20 to a second axial end 22 opposite the first axial end 20. The plurality of windings 18 extend along the stator core 16. Each of the plurality of windings 18 respectively includes a terminal end 24 that is positioned axially beyond the second axial end 22 of the stator core 16 in the first axial direction. At least one of the plurality of windings 18 is fixed to a busbar 26 proximate to the terminal end 24 of the at least one winding 18. A tray 28 is coupled to and supports the busbar 26. The tray 28 defines at least one receiver 30 through which the at least one winding 18 extends.

Referring now to FIG. 1, the electric motor assembly 10 may be a portion of an electric drive unit 32 for a vehicle, as illustrated in FIG. 1. The electric motor assembly 10 includes the rotor 12 and the stator 14 that is disposed radially outboard of the rotor 12. As illustrated in FIG. 1, a rotor shaft 34 may be positioned radially inboard of the rotor 12 and may be configured to rotate about an axis 36 during operation of the electric motor assembly 10. The electric drive unit 32 may include a variety of other components, including a housing 38 that houses the motor, a gearset 40 operably coupled with the rotor shaft 34, and/or a differential 42 operably coupled with the gearset 40.

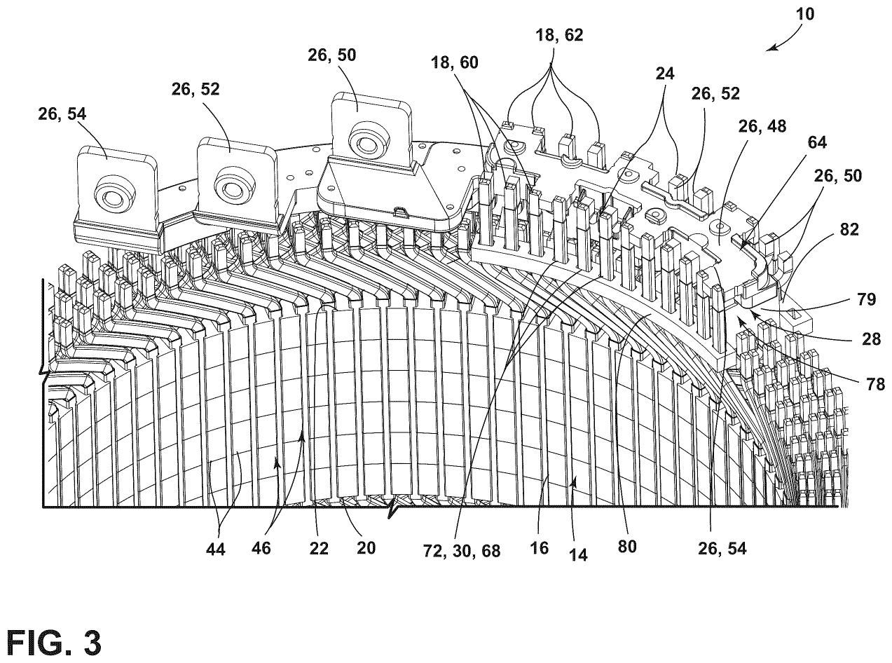

Referring now to FIGS. 1-5, the stator 14 of the electric motor assembly 10 includes the stator core 16. As illustrated in FIGS. 1-3, the stator core 16 extends axially in the first axial direction from the first axial end 20 of the stator core 16 to the second axial end 22 of the stator core 16 that is opposite the first axial end 20. As illustrated in FIG. 3, the stator core 16 can include a plurality of teeth 44 that are circumferentially spaced apart to define a plurality of gaps 46 between adjacent teeth 44. The stator 14 further includes the plurality of windings 18. The plurality of windings 18 extend along the stator core 16. In various implementations, the windings 18 extend within the gaps 46 defined between adjacent teeth 44 of the stator core 16, as illustrated in FIG. 3. Each of the windings 18 includes a terminal end 24 that is positioned axially beyond the second axial end 22 of the stator core 16 in the first axial direction. As described further herein, the windings 18 may be fixed to the busbar 26 proximate the terminal ends 24 of the windings 18.

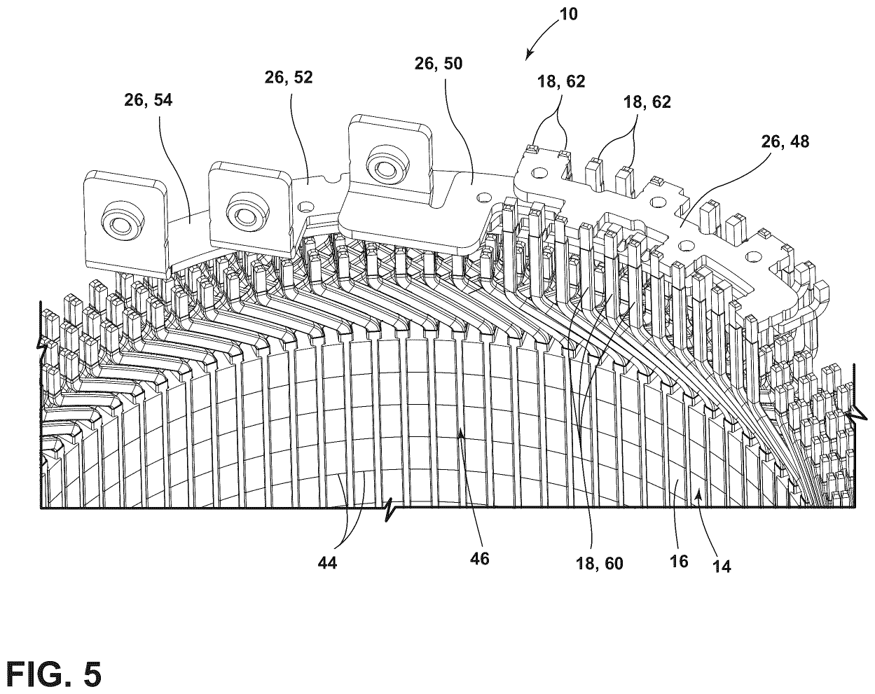

Referring still to FIGS. 1-5, the electric motor assembly 10 includes the busbar 26. In various implementations, the electric motor assembly 10 includes a plurality of busbars 26. For example, as illustrated in FIG. 5, the electric motor assembly 10 includes a first busbar 48, a second busbar 50, a third busbar 52, and a fourth busbar 54. In the exemplary embodiment illustrated in FIG. 3, the first busbar 48 is neutral, the second busbar 50 is U-phase, the third busbar 52 is V-phase, and the fourth busbar 54 is W-phase. It is contemplated that various numbers of busbars 26 can be included in the electric motor assembly 10, and the busbars 26 may be associated with various phases, in some embodiments. The busbar 26 of the electric motor assembly 10 can include one or more radially-outboard-facing surfaces 56 and one or more radially-inboard-facing surfaces 58.

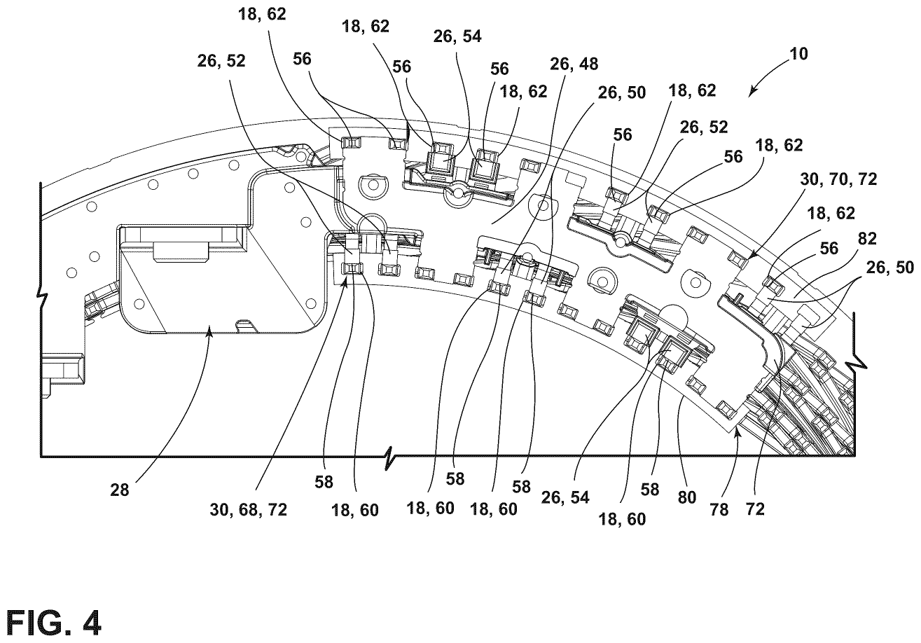

Referring still to FIGS. 1-5, the plurality of windings 18 are fixed to the one or more busbars 26. In various implementations, the plurality of windings 18 are fixed to the one or more busbars 26 proximate to the terminal ends 24 of the windings 18. In some implementations, the plurality of windings 18 includes at least one inner winding 60 and at least one outer winding 62. As illustrated in FIG. 4, the at least one inner winding 60 is coupled to a radially-inboard-facing surface 58 of the busbar 26, and the at least one outer winding 62 is fixed to the radially-outboard-facing surface 56 of the busbar 26. The windings 18 may be fixed to the one or more busbars 26 in a variety of manners. For example, in some implementations, the windings 18 may be welded to the one or more busbars 26. In some implementations, the windings 18 may be fixed to the one or more busbars 26 via a conductive adhesive.

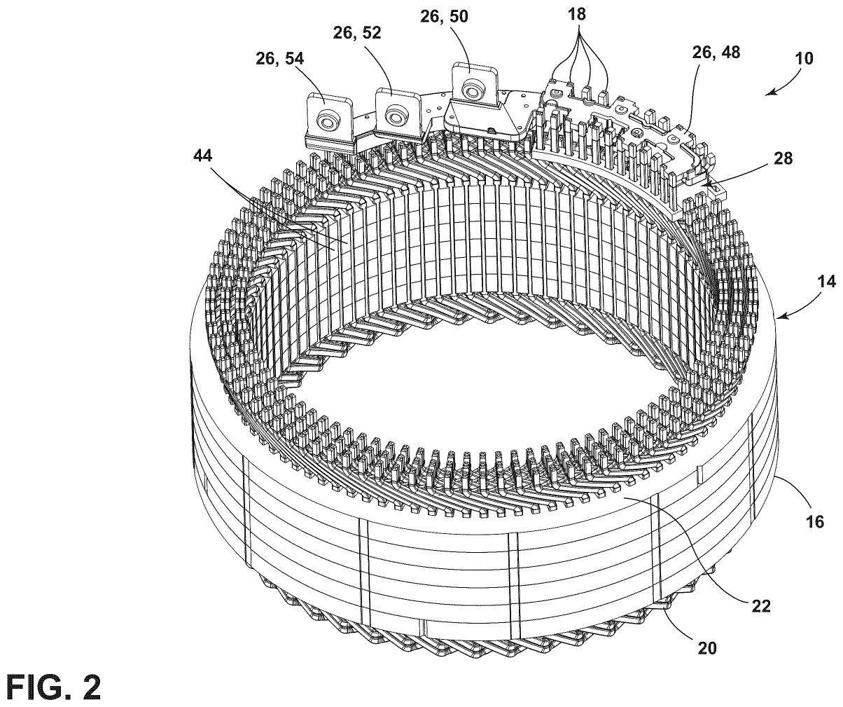

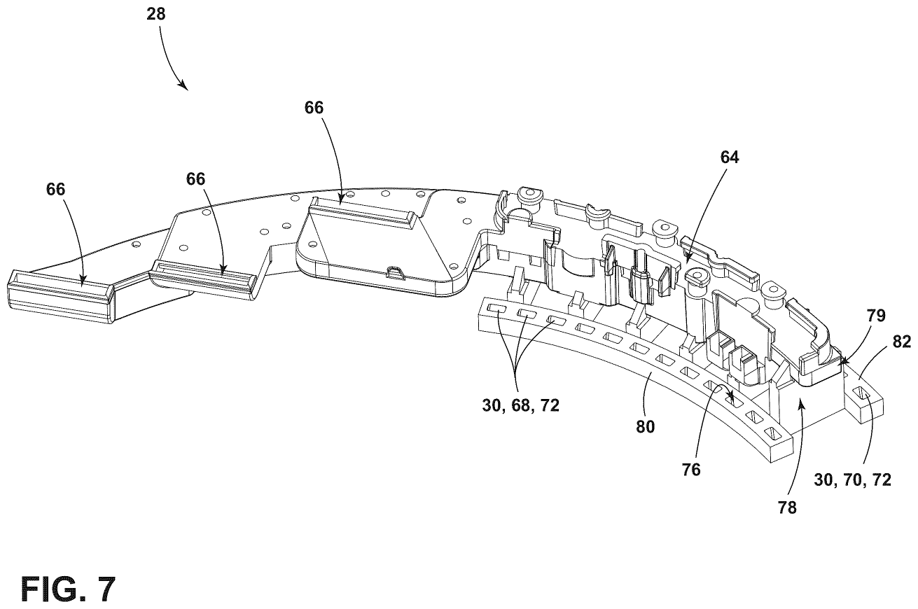

Referring now to FIGS. 2-8, the electric motor assembly 10 includes the tray 28. The tray 28 is coupled to the busbar 26 and supports the busbar 26. As illustrated in FIGS. 3, 4, and 6, the tray 28 defines a recess 64 for receiving the first busbar 48, and a plurality of hollows 66 for receiving the second, third, and fourth busbars 50, 52, 54 therein, respectively. The busbars 26 are supported by the tray 28 while disposed in the recess 64 and/or hollows 66 defined by the tray 28. In various implementations, the tray 28 defines at least one receiver 30 that is positioned axially between the busbar 26 and the stator core 16 of the electric motor assembly 10. As illustrated in FIGS. 3, 4, 6, and 7, the tray 28 defines a plurality of receivers 30. The receivers 30 are configured to receive corresponding windings 18 therethrough, as illustrated in FIGS. 3 and 4. As illustrated in FIGS. 4 and 7, in various implementations, the plurality of receivers 30 can include at least one inner receiver 68 as defined by the tray 28 and at least one outer receiver 70 that is defined by the tray 28 and positioned radially outboard of the at least one inner receiver 68. As illustrated in FIG. 7, the tray 28 defines a plurality of inner receivers 68 and a plurality of outer receivers 70 positioned radially outboard of the plurality of inner receivers 68.

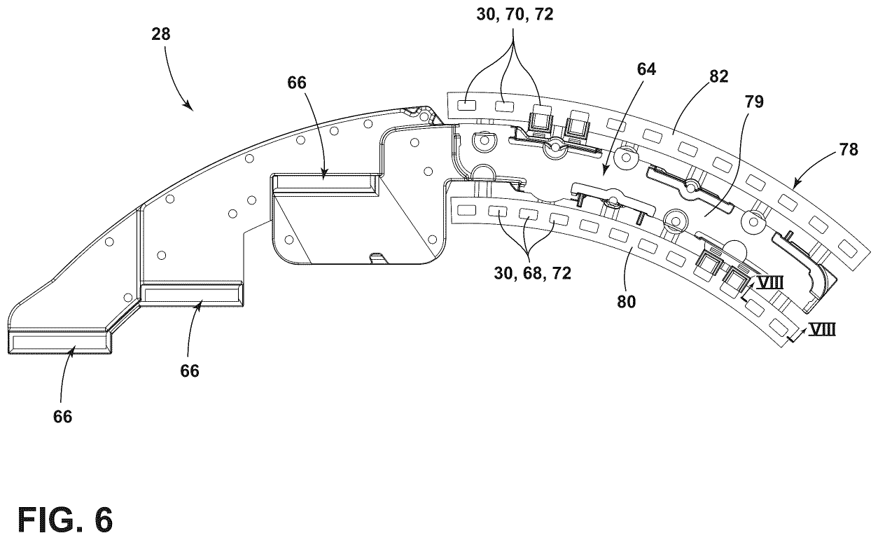

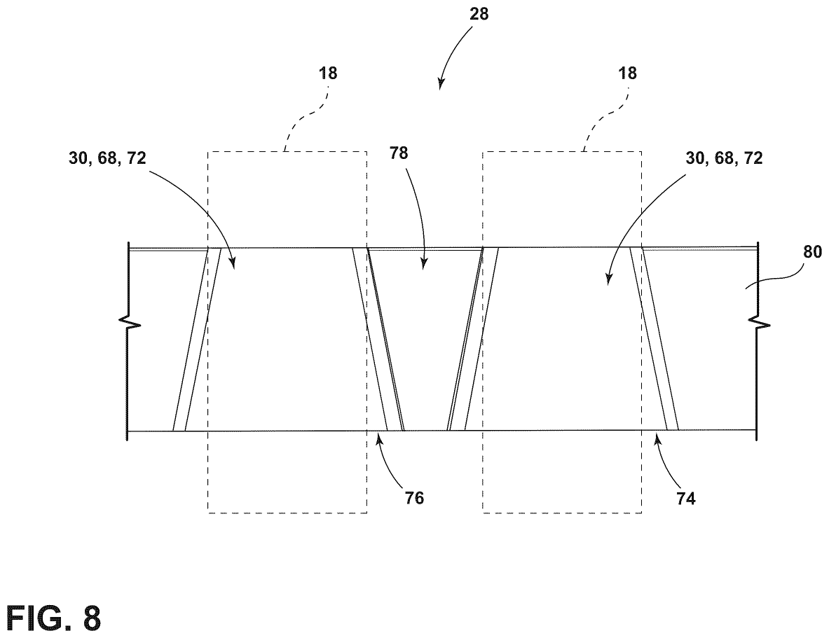

Referring now to FIGS. 6-8, in some implementations, the at least one receiver 30 defined by the tray 28 includes at least one aperture 72. For example, as illustrated in FIGS. 6 and 7, the tray 28 defines a plurality of receivers 30 in the form of apertures 72. It is contemplated that a variety of other types of receivers 30 may be defined by the tray 28 and configured to receive corresponding windings 18 therethrough. For example, the receiver 30 defined by the tray 28 may be a slot that, while technically not an aperture 72, still restricts removal of the winding 18 via movement of the winding 18 in directions perpendicular to the lengthwise direction of the portion of the winding 18 that extends through the receiver 30. In various implementations, at least one receiver 30 defined by the tray 28 extends from a first opening 74 to a second opening 76 that is axially offset from the first opening 74. As illustrated in FIG. 8, the portion of the tray 28 that defines the at least one receiver 30 may taper inward as the portion extends axially in the first axial direction, such that the first opening 74 of the at least one receiver 30 is larger than the second opening 76 of the at least one receiver 30, as illustrated in FIG. 8. In the embodiment illustrated in FIG. 8, the tray 28 defines a plurality of apertures 72 that extend from the first opening 74 to the second opening 76 in the first axial direction. As illustrated, the first opening 74 is larger than the second opening 76 due to the inward tapering of the portions of the tray 28 that define the apertures 72. The inward tapering of the portions of the tray 28 that define the apertures 72 can result in a friction fit with windings 18 extending therethrough, such that the movement of the windings 18 in directions parallel to the lengthwise direction of the portion of the winding 18 that extends through the aperture 72. It is contemplated that embodiments of the tray 28 that define receivers 30 that are not apertures 72 may restrict movement of the windings 18 in directions parallel to the lengthwise direction of the portion of the winding 18 that extends through the receivers 30, in various embodiments.

Referring now to FIGS. 3, 4, 6, and 7, in various implementations, the tray 28 includes a support structure 78. The support structure 78 is configured to support at least one busbar 26 of the electric motor assembly 10. Further, the support structure 78 defines the plurality of apertures 72 configured to receive the corresponding plurality of windings 18 therethrough. The support structure 78 includes a body 79 that is configured to support the at least one busbar 26. For example, in the embodiment illustrated in FIGS. 3 and 6, the body 79 of the support structure 78 defines the recess 64 that receives the first busbar 48 therein. The support structure 78 may include a guide member that is coupled to the body 79 and that defines a plurality of the receivers 30. In the embodiment illustrated in FIGS. 3, 4, 6, and 7, the support structure 78 of the tray 28 includes an inner guide member 80 and an outer guide member 82. The inner guide member 80 extends radially inboard from the body 79 and defines a plurality of inner apertures 68, as illustrated in FIG. 7. The outer guide member 82 extends radially outward from the body 79 and defines a plurality of outer apertures 70. As illustrated in FIG. 7, the inner and outer guide members 80, 82 are generally arcuate and the pluralities of inner and outer receivers 68, 70 that are respectively defined by the inner and outer guide members 80, 82 are circumferentially spaced apart from each other along the arcuate extents of the inner and outer guide members 80, 82. As illustrated in FIG. 7, a radially-inboard-most portion of the inner guide member 80 at a given circumferential position that is occupied by the inner guide member 80 is the radially-inboard-most portion of the tray 28 at the given circumferential position occupied by the inner guide member 80. Further, the radially-outboard-most portion of the outer guide member 82 at a given circumferential position occupied by the outer guide member 82 is the radially-outboard-most portion of the tray 28 at the given circumferential position occupied by the outer guide member 82. In various implementations, the tray 28 is formed of plastic or another material with low conductivity.

Referring now to FIGS. 1-8, in an exemplary embodiment of the electric motor assembly 10, first, second, third, and fourth busbars 48, 50, 52, 54 are coupled to and supported by a body 79 of a tray 28. The tray 28 includes the inner guide member 80 that is coupled to the body 79, and the outer guide member 82 that is coupled to the body 79. The inner guide member 80 defines a plurality of inner apertures 68, and the outer guide member 82 defines a plurality of outer apertures 70. Each of the inner and outer apertures 68, 70 extends in the first axial direction from the first opening 74 to the second opening 76. The first opening 74 is larger than the second opening 76. The first opening 74 being larger than the second opening 76 allows for relatively easy insertion of terminal ends 24 of the pluralities of inner and outer windings 60, 62 through the corresponding inner and outer apertures 68, 70, respectively, in the first axial direction, as the tray 28 is moved in a second axial direction opposite the first axial direction into an assembled condition, as illustrated in FIG. 3. The second opening 76 of each of the pluralities of inner and outer apertures 68, 70 being smaller than the first opening 74 ensures that contact between the tray 28 and the windings 18 received through the apertures 72 is maintained, such that forces applied to the windings 18 are transferred to the tray 28. As illustrated in FIG. 4, one or more of the plurality of inner windings 60 is fixed to a radially-inboard-facing surface 58 of each of the first, second, third, and fourth busbars 48, 50, 52, 54. Further, one or more of the plurality of outer windings 62 are fixed to a radially-outboard-facing surface 56 of each of the first, second, third, and fourth busbars 48, 50, 52, 54.

In operation of the exemplary embodiment, the tray 28 supports the busbars 26 and restricts movement of the windings 18 that are fixed to the busbars 26 relative to the busbars 26. As such, connection points between the windings 18 and the busbars 26 are shielded from stresses that may otherwise cause disconnection.

It is to be understood that variations and modifications can be made on the aforementioned structure without departing from the concepts of the present disclosure, and further it is to be understood that such concepts are intended to be covered by the following claims unless these claims by their language expressly state otherwise.

### LIST OF REFERENCE NUMERALS

10 electric motor assembly
12 rotor
14 stator
16 stator core
18 windings
20 first axial end
22 second axial end
24 terminal end
26 busbar
28 tray
30 receiver
32 electric drive unit
34 rotor shaft
36 axis
38 housing
40 gearset
42 differential
44 teeth
46 gaps
48 first busbar
50 second busbar
52 third busbar
54 fourth busbar
56 radially-outboard-facing surface
58 radially-inboard-facing surface
60 inner winding
62 outer winding
64 recess
66 hollow
68 inner receiver/aperture
70 outer receiver/aperture
72 aperture
74 first opening
76 second opening
78 support structure
79 body
80 inner guide member
82 outer guide member

What is claimed is:

1. An electric motor assembly, comprising:
a rotor;
a stator disposed radially outboard of the rotor and comprising:
a stator core that extends axially in a first axial direction from a first axial end to a second axial end opposite the first axial end; and
a plurality of windings that extend along the stator core, each of which respectively includes a terminal end that is positioned axially beyond the second axial end of the stator core in the first axial direction;
a busbar to which at least one of the plurality of windings is fixed proximate to the terminal end of the at least one winding; and
a tray coupled to and supporting the busbar and defining at least one receiver through which the at least one winding extends.

2. The electric motor assembly of claim 1, wherein the at least one receiver is positioned axially between the busbar and the stator core.

3. The electric motor assembly of claim 2, wherein the at least one receiver extends from a first opening to a second opening that is axially offset from the first opening, and the portion of the tray that defines the at least one receiver tapers inward as the portion extends axially in the first axial direction, such that the first opening is larger than the second opening.

4. The electric motor assembly of claim 3, wherein the tray is configured to maintain contact with the at least one winding at the second opening of the at least one receiver.

5. The electric motor assembly of claim 1, wherein the at least one receiver comprises at least one aperture.

6. The electric motor assembly of claim 1, wherein the at least one winding that extends through the at least one receiver defined by the tray is fixed to at least one of a radially-outboard-facing surface of the busbar and a radially-inboard-facing surface of the busbar.

7. The electric motor assembly of claim 6, wherein the at least one winding that extends through the at least one receiver defined by the tray is fixed to the radially-outboard-facing surface of the busbar.

8. The electric motor assembly of claim 6, wherein the at least one winding that extends through the at least one receiver defined by the tray is fixed to the radially-inboard-facing surface of the busbar.

9. The electric motor assembly of claim 6, wherein the at least one receiver comprises:
at least one inner receiver defined by the tray; and
at least one outer receiver that is defined by the tray and positioned radially outboard of the at least one inner receiver.

10. The electric motor assembly of claim 9, wherein the at least one winding comprises:
at least one inner winding that extends through the at least one inner receiver defined by the tray and that is fixed to the radially-inboard-facing surface of the busbar; and
at least one outer winding that extends through the at least one outer receiver defined by the tray and that is fixed to the radially-outboard-facing surface of the busbar.

11. The electric motor assembly of claim 10, wherein the at least one inner receiver includes a plurality of inner receivers, the at least one outer receiver includes a plurality of outer receivers, the at least one inner winding includes a plurality of inner windings that respectively extend through the corresponding plurality of inner receivers, and the at least one outer winding includes a plurality of outer windings that respectively extend through the corresponding plurality of outer receivers.

12. The electric motor assembly of claim 11, wherein the tray comprises:
a body that supports the busbar;
an inner guide member that extends radially inboard from the body and defines the plurality of inner receivers; and
an outer guide member that extends radially outboard from the body and defines the plurality of outer receivers.

13. The electric motor assembly of claim 12, wherein a radially-inboard-most portion of the inner guide member at a given circumferential position occupied by the inner guide member is the radially-inboard-most portion of the tray at the given circumferential position occupied by the inner guide member.

14. The electric motor assembly of claim 12, wherein a radially-outboard-most portion of the outer guide member at a given circumferential position occupied by the outer guide member is the radially-outboard-most portion of the tray at the given circumferential position occupied by the outer guide member.

15. A tray for an electric motor assembly, comprising:
a support structure configured to support at least one busbar of the electric motor assembly and defining a plurality of apertures configured to receive a corresponding plurality of windings therethrough that are configured to be fixed to the at least one busbar.

16. The tray of claim 15, wherein at least one the plurality of apertures extends from a first opening to a second opening, and wherein the first opening is larger than the second opening.

17. The tray of claim 15, wherein the plurality of apertures includes a plurality of inner apertures and a plurality of outer apertures positioned radially outboard of the plurality of inner apertures, and wherein the support structure comprises:
a body that is configured to support the at least one busbar;
an inner guide member that extends radially inboard from the body and defines the plurality of inner apertures; and
an outer guide member that extends radially outboard from the body and defines the plurality of outer apertures.

18. The tray of claim 17, wherein a radially-inboard-most portion of the inner guide member at a given circumferential position occupied by the inner guide member is the radially-inboard-most portion of the tray at the given circumferential position occupied by the inner guide member.

19. The tray of claim 18, wherein a radially-outboard-most portion of the outer guide member at a given circumferential position occupied by the outer guide member is the radially-outboard-most portion of the tray at the given circumferential position occupied by the outer guide member.

20. An electric motor assembly, comprising:
a stator, comprising:
a stator core; and
a plurality of windings that extend along the stator core;
a busbar to which the plurality of windings are fixed; and
a tray coupled to and supporting the busbar and defining a plurality of apertures through which the plurality of windings respectively extend.
